(19) United States
(12) Patent Application Publication
(10) Pub. No.: US 2025/0345218 A1
(43) Pub. Date: Nov. 13, 2025

(54) MOBILITY IMPAIRED REHABILITATION WHEELCHAIR

(71) Applicant: Anthony Andrew Cassidy, Drogheda (IE)

(72) Inventor: Anthony Andrew Cassidy, Drogheda (IE)

(21) Appl. No.: 19/203,425

(22) Filed: May 9, 2025

Related U.S. Application Data
(60) Provisional application No. 63/644,549, filed on May 9, 2024.

(51) Int. Cl. A61G 5/02; A61G 5/04; A61G 5/10; A61G 5/12

(52) U.S. Cl. CPC A61G 5/022; A61G 5/045; A61G 5/101; A61G 5/1032; A61G 5/128

(57) ABSTRACT

A mobility impaired rehabilitation wheelchair having both a manual mode of operation and a motorized mode of operation for use by a wheelchair occupant in providing efficient and reliable leg exercising for improving circulation and providing muscular stimulation. The mobility impaired rehabilitation wheelchair has an electrical motor and shaft movement that is compact in nature for enabling the motorized mode of operation and the mechanical design provides the wheelchair occupant with a leaver to control movement and the ability to disconnect motion in the manual mode of operation.

### CROSS-REFERENCE TO RELATED APPLICATIONS

This application claims the benefit of U.S. Provisional Patent Application No. 63/644,549 filed on May 9, 2024, which is incorporated by reference herein in its entirety.

### FIELD OF THE INVENTION

The present invention relates generally to wheelchairs, and more particularly, to a wheelchair for use by mobility impaired individuals that provides leg exercising for improving circulation and providing muscular stimulation.

### BACKGROUND OF THE INVENTION

The wheelchair is one of the most commonly used assistive devices to promote mobility and enhance quality of life for people who have difficulties in walking (e.g., a person with spinal cord injuries resulting in quadriplegia or paraplegia, muscular dystrophy, etc.). Wheelchair mobility opens up opportunities for wheelchair users to study, work, engage in social activities and access services such as healthcare. In addition to providing mobility, an appropriate wheelchair benefits the physical health and quality of life of the users by helping in reducing common problems such as pressure sores, progression of deformities and improve respiration and digestion. Many different kinds of disabilities require the use of wheelchairs for mobility. These are referred to as mobility impairments. Disabilities may be orthopedic (relating to the bone and muscles), or they may be neuromuscular (relating to the nerves and muscles). For example, some of the more common kinds of mobility impairments are amputations, paralysis, spinal cord injuries, cerebral palsy, multiple sclerosis, muscular dystrophy, and more. Medical conditions that require wheelchairs have a wide range of types and presentations, but finding a wheelchair that meets each person's individual needs is particularly important. The right wheelchair, whether manual or electronic, sitting or standing, reclining or tilting, will be the one that offers the best opportunities for comfort, independence, and mobility.

Typical sitting wheelchair designs employ a sturdy frame supporting a seat assembly. The seat assembly includes arm rests and push bars to allow the wheelchair to be pushed by an aide. Attached to the rear of the frame is a pair of drive wheels. The drive wheels are typically large diameter wheels attached to a central hub with spokes. Push rims are mounted to the drive wheels to allow the wheelchair occupant to propel the chair using their arms and upper body. A smaller pair of pivoting castor wheels is attached to the front of the frame to provide steerability. Extending down from the lower front of the wheelchair frame is a footrest system to support the lower legs. The footrest system typically includes a pair of bars, one mounted to each side of the frame. Attached to each bar is a footrest, which typically may be pivoted up and out of the way to provide clearance if the occupant so desires. Adjustment mechanisms allow each bar to slide in adjustment relative to the frame to accommodate the differing heights and leg lengths of the wheelchair occupant.

One drawback to existing wheelchairs is that the footrest system, once adjusted for the particular size of the occupant, remains locked in a fixed position. As a result, the occupant's legs are stationary while seated in the wheelchair. Over extended periods of time, a wheelchair occupant who is not able to move their legs on their own may develop atrophy in the leg muscles and contracture of the leg joint ligaments. Moreover, prolonged leg immobility substantially increases risks of blood clotting or arterial blockage. Either of these problems with blood circulation can cause death either incrementally via necrosis and infection, which may be averted by amputation; or, more immediately, via dislodgement of a clot or blockage that subsequently blocks a cardiac, pulmonary, or cranial artery. Therefore, efforts to prevent muscle atrophy and contractures, as well as circulatory deficiencies, by providing for continuous or periodic motion of a wheelchair occupant's legs are important in order to improve their utility and protect the user's health.

Accordingly, there is a need for a wheelchair that will efficiently and reliably maintain circulation in the legs of a wheelchair user.

### SUMMARY OF THE INVENTION

The present invention is directed to a mobility impaired rehabilitation wheelchair providing users with efficient and reliable leg exercising for improving circulation and providing muscular stimulation.

In a first implementation of the invention, a mobility impaired rehabilitation wheelchair is provided having a manual mode of operation and a motorized mode of operation, the mobility impaired rehabilitation wheelchair comprising:
a pair of front wheel assemblies each front wheel assembly comprising at least a front wheel;
a pair of rear wheel assemblies, each rear wheel assembly comprising at least a rear wheel;
a frame connected with and supported by the pair of front wheel assemblies and the pair of rear wheel assemblies;
a movable foot rest support assembly connected with the frame and comprising at least a first foot rest and a second foot rest;
a coupling rod comprising a first end and a second end;
a rotatable plate attached to the first end of the coupling rod and to a first one rear wheel assembly of the pair of rear wheel assemblies;
a coupling rod adjustment portion attached to the second end of the coupling rod and to each movable foot rest support assembly of the pair of foot rest assemblies;
a lever arm comprising a level arm support, a lever arm support hinge pin and a lever arm hinge joint, the lever arm having a first end and a second end and capable of being placed in a first position and a second position as governed by the lever arm hinge joint and the lever arm hinge pin, and wherein the first position of the lever arm disables the manual operation of the mobility impaired rehabilitation wheelchair and the second position of the lever arm enables the manual mode of operation of the mobility impaired rehabilitation wheelchair;
a first drive gear connected with the first end of the lever arm and in contact with a first side of the rotatable plate;
a second drive gear in contact with the first one rear wheel assembly and capable of applying a driving force to the rear wheel thereof;
a third drive gear in contact with the first end of the lever arm and a first side of the rotatable plate and wherein the third drive gear is capable of being engaged and mated to the first drive gear and the second gear when the lever arm is in the second position and disengaged and unmated with the first drive gear and the second drive gear when the lever arm is in the first position, and wherein the first drive gear, the second drive gear, and the third drive gear are capable of applying a first driving force to the coupling rod when the lever arm is in the second position and the mobility impaired rehabilitation wheelchair is in motion due the manual operation thereof;
an electric motor capable of applying a second driving force in the motorized mode of operation to the coupling rod but only when the lever arm is in the first position;
a control panel capable of operating and controlling the motorized operation of the mobility impaired rehabilitation wheelchair;
a battery capable of powering the electric motor; and
wherein the first driving force or the second driving force when applied to the coupling rod in either the manual mode of operation or the motorized mode of operation causes a substantially linear oscillating motion of the first foot rest and the second foot rest of the movable foot rest support assembly.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a side of a mobility impaired rehabilitation wheelchair in accordance with an embodiment;

FIG. 2 presents another side view of the mobility impaired rehabilitation wheelchair with a rotational mechanism in accordance with an embodiment;

FIG. 3 presents a rear view of a back wheel and assembly of the mobility impaired rehabilitation wheelchair in accordance with an embodiment;

FIG. 4 presents a front view of a back wheel and assembly of the mobility impaired rehabilitation wheelchair in accordance with an embodiment;

FIG. 5 presents a side view of a foldable lever arm of the mobility impaired rehabilitation wheelchair in accordance with an embodiment;

FIG. 6A presents a diagram showing motion engagement for the mobility impaired rehabilitation wheelchair in accordance with an embodiment;

FIG. 6B presents a diagram showing motion disengagement for the mobility impaired rehabilitation wheelchair in accordance with an embodiment;

FIG. 7 presents another side view of the mobility impaired rehabilitation wheelchair without any mobility mechanism in accordance with an embodiment;

FIG. 8 presents a sectional side view of the mobility impaired rehabilitation wheelchair in accordance with an embodiment;

FIG. 9 presents a front view of an operational control portion of the mobility impaired rehabilitation wheelchair in accordance with an embodiment; and

FIG. 10 presents a schematic view of a controller for the mobility impaired rehabilitation wheelchair in accordance with an embodiment.

Like reference numerals refer to like parts throughout the several views of the drawings.

### DETAILED DESCRIPTION

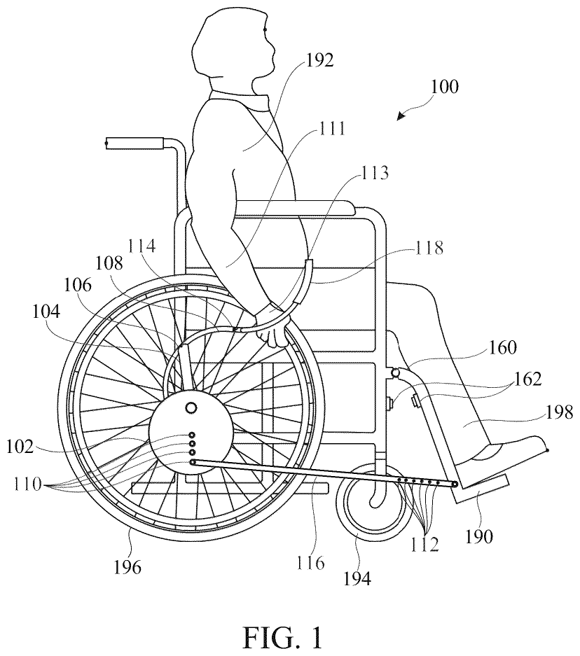

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a mobility impaired rehabilitation wheelchair having both a manual mode of operation and a motorized mode of operation for providing users (e.g., a wheelchair occupant) with efficient and reliable leg exercising for improving circulation and providing muscular stimulation.

Referring to FIGS. 1-5, 6A-B and 7-8, wherein matching components are given matching reference numbers, a mobility impaired rehabilitation wheelchair 100 is shown in accordance with an embodiment. As shown, the mobility impaired rehabilitation wheelchair 100 comprises at least holding portion 101, rotatable 102 that will provide motion through coupling rod 116 having a first end and second end to movable foot rest support assembly 190 for exercising legs 198 of wheelchair occupant 192 as will be further detailed herein. The movable foot rest support assembly 190 comprising at least a first foot rest (e.g., a left foot rest) and a second foot rest (e.g., a right foot rest). The mobility impaired rehabilitation wheelchair 100 further includes armrests 103, lever arm support 104, frame 105, lever arm support hinge pin 106, backrest portion 107, lever arm hinge joint 108, seat portion 109, rotation adjustment portion 110 and coupling arm adjustment portion 112 that allows for a plurality of variable positions due to variable rotation circles (e.g., position and rotation circle 124, position and rotation circle 126, position and rotation circle 128, and position and rotation circle 130) and rotational speeds to be applied to the movable foot rest support assembly 190 either manually (e.g., as the wheelchair occupant 192 rotates rear wheels assembly 196 with their arms 111 and hands 113 or using electrical motor 158 powered by battery 170 for driving the rotatable 102 and associated assemblies such that the movable foot rest support assembly 190 may be displaced and moved (e.g., through coupling horizontal drive 168) in a back and forth motion 188 to a first position 184 and a second position 186 thereby exercising the legs 198 of the wheelchair occupant 192 for improving at least circulation and providing muscular stimulation. Illustratively, the electrical motor 158 and/or the battery 170 may be mounted securely to the frame 105 and/or the underside of the seat portion 109 and/or the backrest portion 107 using any type of suitable fasteners (not shown) including, but not limited to, brackets, bolts, harnesses, and other types of rigid members. The movements are further enabled and controlled via front rigging hinge 160, rubber stoppers 162, coupling rod 164, coupling rod pivot points 166 and coupling rod horizontal drive 168. The movable foot rest support assembly 190 are located on a front end of the frame 105 and are each respectively located on two sides of the frame 105 in a substantially horizontal direction. In an embodiment, the motion of the movable foot rest support assembly 190 is substantially vertical. Rear wheels assembly 196 on a rear end of the frame 105 while front wheels assembly 194 are located on a front end of the frame 105 (more proximate to the movable foot rest support assembly 190) and are each pairs of wheels located on two sides of the frame 105. Thus, the frame 105 is supported by at least the front wheels assembly 194 and the rear wheels assembly 196. Further, of the rear wheels assembly 196 conventionally includes a drive wheel and a push rim, which are radially connected to enable a wheelchair occupant to propel the mobility impaired rehabilitation wheelchair 100 using their arms and upper body. The drive wheel is radially connected to a hub and the drive wheel typically includes a metal or hard polymer rim on which a soft polymer tire is mounted. The push rim typically includes a metal or hard polymer rail extending circumferentially, and optionally includes a soft grip mounted on the rail. Each front wheel of the front wheels assembly 194 may be pivotally connected to the frame 105 and wheel may be rotatably mounted within a wheel bracket (not shown). In this way, the front wheels assembly 194 may freely swivel to permit steering of the mobility impaired rehabilitation wheelchair 100 without any or substantially no skid.

The seat portion 109 and backrest portion 107 include conventional elements for supporting the wheelchair occupant such as a seat back supported between upper vertical structural members of the frame 105, the arm rests 103 are supported on upper horizontal structural members of the frame 105, and a sling seat, for example, may be supported between members of the frame 105. Any elements of the seat portion 109 and backrest portion 107 that extend between the frame 105 footprint typically are made of fabric or flexible polymer to permit collapsing to avoid damage or harm. The foot assemblies 190 are provided at the front of the frame 105 to support the feet and lower legs of the wheelchair occupant. Each footrest assembly 190 may be pivotally supported on a bar (not shown) that is rigidly mounted to one member of the frame 105. The foot rest assemblies 190 typically may be pivoted up and out of the way for ease of entering or leaving the mobility impaired rehabilitation wheelchair 100. However, once lowered for use by the wheelchair occupant in a conventional wheelchair, the footrests may be fixedly mounted to the frame 105. As a result, the occupant's legs are stationary while seated therein, leading to the physical problems of the wheelchair occupant addressed by principles of the disclosed embodiments. In contrast, as detailed in the subject disclosure, the mobility impaired rehabilitation wheelchair 100 includes a foot rest support movably connected to the wheelchair frame by a movable foot rest support assembly. The movable foot rest support assembly 190 is connected to a rear wheel of one of the rear wheel assemblies 196 via the coupling rod 116 at the second end thereof, and a first, second, and third drive gears (e.g., small drive gear 132, wheel drive gear 134, and plate drive gear 136), so that normal operation of the wheelchair drives substantially linear vertical oscillating motion of the foot supports. That is, the advantages of the subject disclosure are that the gently oscillating motion of the movable foot rest support assembly 190 will result in at least improved circulation, reduction in clotting, reduces rates of leg muscle atrophy, and ligament contracture for the wheelchair occupant 192 as compared to conventional wheelchairs.

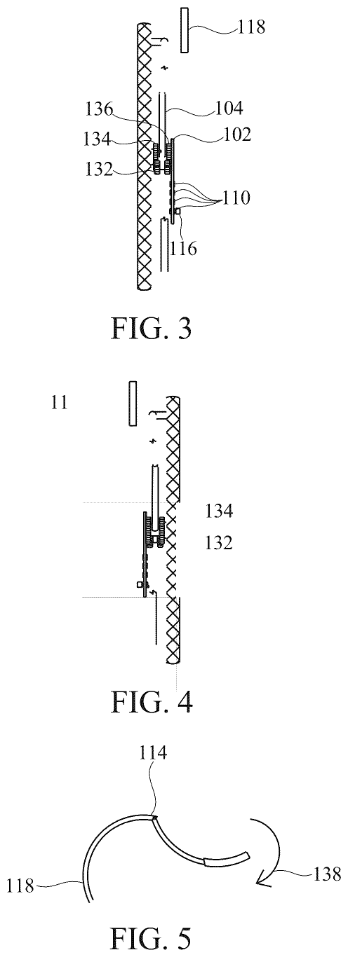

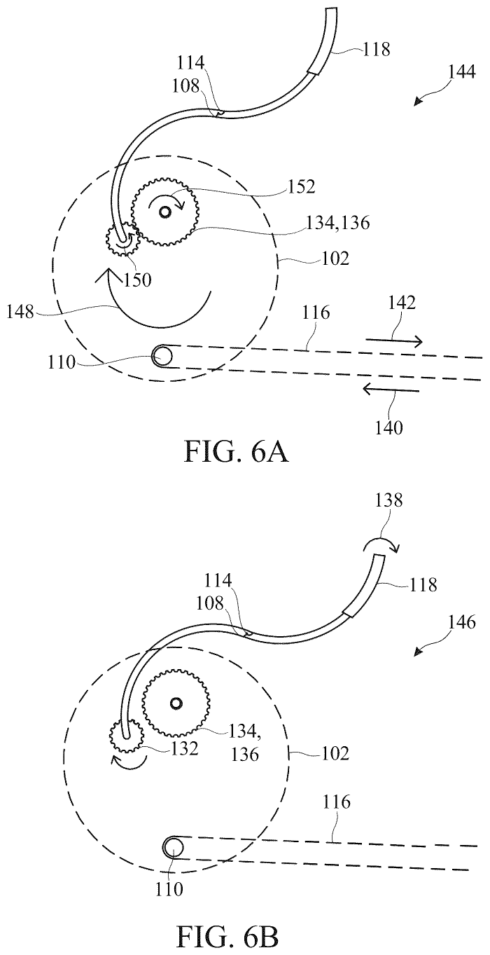

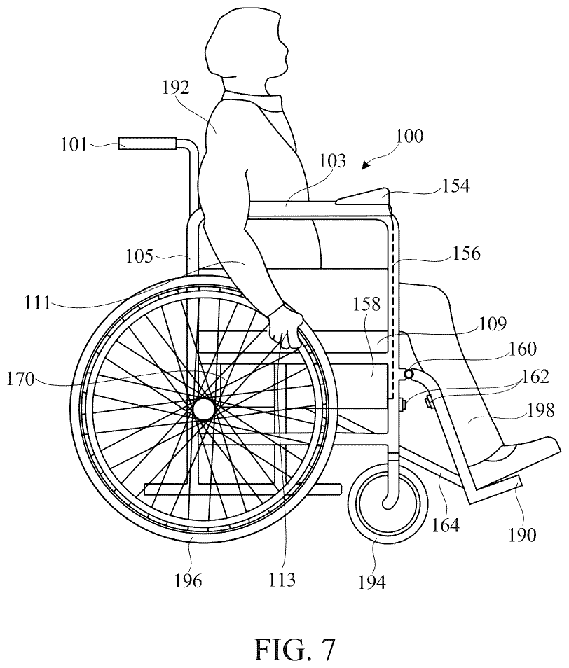

Continuing with such circulation and stimulation movements in the subject embodiment, lever arm 118 is used to initiated and stop movements under the control of the wheelchair occupant 192. That is, the wheelchair occupant 192 may control which operations mode is engaged (i.e., either the manual mode or the motorized mode) at any one time. Each of the manual mode and the motorized mode when engaged will apply a driving force as detailed below. In particular, as shown for example in FIGS. 6A and 6B, operation of the lever arm 118 by the wheelchair occupant (e.g., motion 138 from a first position to a second position thereby going from a static position to an in-motion position) by and through at least the lever arm hinge joint 108 and the lever arm hinge pin 114 (see, e.g., FIGS. 3, 4, and 5), will trigger the engagement mechanism 144 or disengagement mechanism 146, as the case may be, of the small drive gear 132, wheel drive gear 134 and plate drive gear 136 that drive the rotation 150 and 152 thereof, respectively, of the rotatable 102 which in turn drives the rotation 148 thereof and the coupling rod 116 (in direction 140 and 142, respectively) in turn driving the wheels of the rear wheels assembly 196 thereby creating motion for displacing and moving the foot rest assemblies 190 to a first position 184 (e.g., outward pushing away from the wheelchair occupant 192) and a second position 186 (e.g., inward pushing towards the wheelchair occupant 192) thereby exercising the legs 198 of the wheelchair occupant 192 for improving circulation and providing muscular stimulation in accordance with the principles of the disclosed embodiments. Illustratively, the first drive gear (e.g., the plate drive gear 136) connected with the first end of the lever arm and in contact with a first side of the rotatable plate. The second drive gear (e.g., the wheel drive gear 134) is in contact with the first one rear wheel assembly and capable of applying a driving force to the rear wheel thereof. The third drive gear (e.g., the small drive gear 132) in contact with the first end of the lever arm and a first side of the rotatable plate and wherein the third drive gear is capable of being engaged and mated to the first drive gear and the second gear when the lever arm is in the second position and disengaged and unmated with the first drive gear and the second drive gear when the lever arm is in the first position, and wherein the first drive gear, the second drive gear, and the third drive gear are capable of applying a first driving force to the coupling rod when the lever arm is in the second position and the mobility impaired rehabilitation wheelchair is in motion due the manual operation thereof. In this way, the first driving force or the second driving force when applied to the coupling rod in either the manual mode of operation or the motorized mode of operation causes a substantially linear oscillating motion of the first foot rest and the second foot rest of the movable foot rest support assembly.

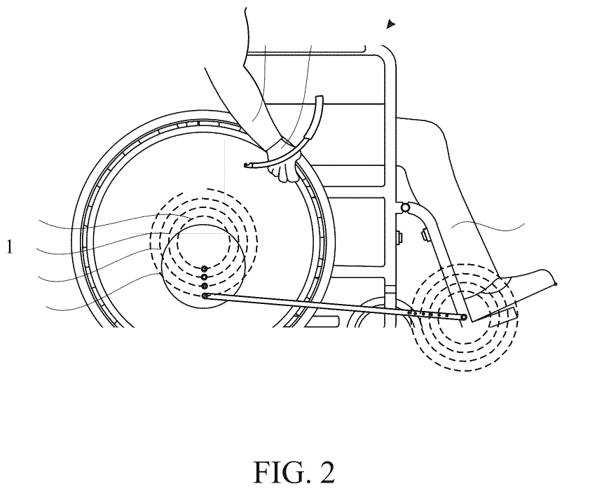

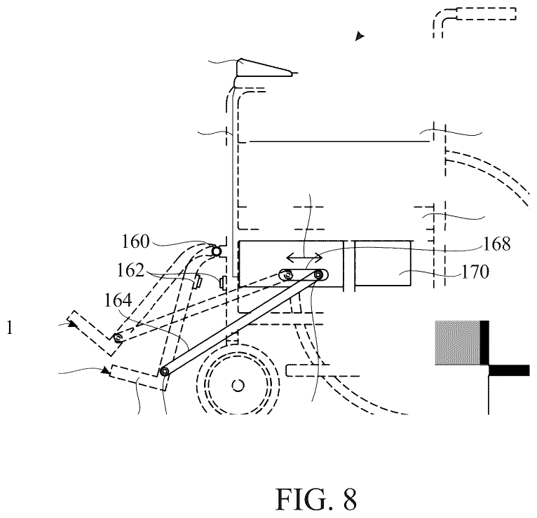

The rotation 148 of the rotatable 102 may be variable in nature to allow for a plurality of speeds using the rotation adjustment 110 in combination with the coupling rod adjustment portion 112 (and the associated coupling rod pivot points 166 and the coupling rod horizontal drive 168, see FIG. 8) which illustratively provides for a plurality of different rotating positions for the rotatable translating to and with the foot rest assemblies 190 (see, e.g., FIG. 2). In this way, in accordance with the principles of the disclosed embodiments, the mobility impaired rehabilitation wheelchair 100 provides a wheelchair occupant with efficient, reliable, gentle and substantially linear vertical motion of their legs for exercising and improving circulation and providing muscular stimulation to assist with lower limb circulation, reducing risks of clotting or blockage within peripheral blood vessels. Additionally, to whatever extent limb atrophy may be reduced by imposed motion, motion of the foot support may help in maintaining muscle mass and flexibility of ligaments.

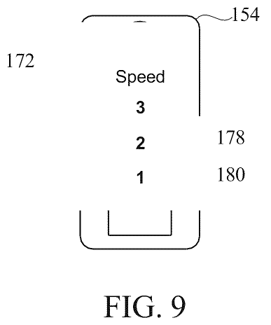

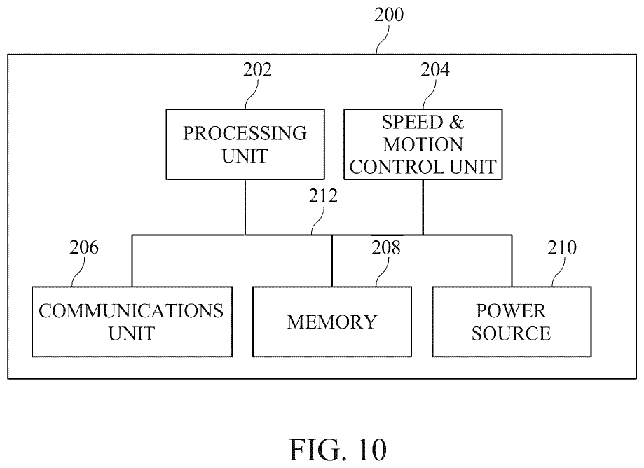

As shown for example in FIG. 8, operational control portion 154 is affixed to one of the armrests 103 to the wheelchair occupant 192 to manage the various operations of the mobility impaired rehabilitation wheelchair 100 when in the motorized operating mode. More particularly, turning our attention to FIG. 9, the operational control portion 154 comprises at least controller 200 (see, FIG. 10) and control panel 174 which allows for variable speeds to be engaged using first control 180, second control 178 and third control 176 (e.g., each configured as a depressible button or other mechanism) to engage a particular speed (e.g., low, medium, and high) transferred by the second driving force of the motorized operating mode. Of course, any number of different speed configurations may be used hereunder. The controller 200 is electrically connected 156 to the operational control portion 154 for operational purposes. Stop control 182 (e.g., a depressible button or other mechanism) may be used to halt all movement and bring the mobility impaired rehabilitation wheelchair 100 to a full stop. Further, audio device 172 may comprise illustratively a speaker and a microphone thereby allowing for voice commands to be spoken by the wheelchair occupant 192 for controlling the mobility impaired rehabilitation wheelchair 100 and playback of audio to the wheelchair occupant 192.

Turning our attention to FIG. 10, a block diagram for the controller 200 is shown in accordance with an embodiment. More particularly, the controller 200 further comprises processing unit 202, memory 208, communications unit 206, speed and motion control unit 204, and power source 210 which are interconnected via bus 212. The processing unit 202 may be used for executing program code (e.g., an applet, microcode or an application program) and communications unit 206 for managing communications to and from the controller 200. The memory 208 may be used for storing program code and data and coupled to the bus 212 for storing computer-readable instructions to be executed by the processing unit 202. The processing unit 202 may include both general and special purpose microprocessors and may be the sole processor or one of multiple processors of the device. Further, the processing unit 202 may comprise one or more central processing units (CPUs) and may include, be supplemented by, or incorporated in, one or more application-specific integrated circuits (ASICs) and/or one or more field programmable gate arrays (FPGAs). The memory 208 may also be utilized for storing temporary variables or other intermediate information during the execution of the instructions by the processing unit 202. The memory 208, such as a magnetic, optical, or solid-state device may be coupled to the bus 212 for storing information and instructions for the processing unit 202. The memory 208 may each comprise a non-transitory computer readable storage medium and may each include high-speed random access memory, such as dynamic random access memory (DRAM), static random access memory (SRAM), double data rate synchronous dynamic random access memory (DDRRAM), or other random access solid state memory devices, and may include nonvolatile memory, such as one or more magnetic disk storage devices such as internal hard disks and removable disks, magneto-optical disk storage devices, optical disk storage devices, flash memory devices, semiconductor memory devices, such as read-only memory (ROM), erasable programmable read-only memory (EPROM), electrically erasable programmable read-only memory (EEPROM), compact disc read-only memory (CD-ROM), digital versatile disc read-only memory (DVD-ROM) disks, or other nonvolatile solid state storage devices

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention. A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those of skill in the art will appreciate that where appropriate, some embodiments of the disclosure may be practiced in network computing environments with many types of computer system configurations, including personal computers, handheld devices, multiprocessor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. “Software” may refer to prescribed rules to operate a computer. Examples of software may include code segments in one or more computer-readable languages; graphical and or/textual instructions; applets; precompiled code; interpreted code; compiled code; and computer programs. A network is a collection of links and nodes (e.g., multiple computers and/or other devices connected together) arranged so that information may be passed from one part of the network to another over multiple links and through various nodes. Examples of networks include the Internet, the public switched telephone network, wireless communications networks, computer networks (e.g., an intranet, an extranet, a local-area network, or a wide-area network), wired networks, and wireless networks.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media. When a single device or article is described herein, it will be readily apparent that more than one device/article (whether or not they cooperate) may be used in place of single device/article. Similarly, where more than one device or article is described herein (whether or not they cooperate), it will be readily apparent that a single device/article may be used in place of the more than one device or article. The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, nontransitory, nonvolatile media, volatile media, and transmission media. Nonvolatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, a RAM, a PROM, an EPROM, a FLASH-EEPROM, removable media, flash memory, a “memory stick”, any other memory chip or cartridge, a carrier wave as described hereinafter, or any other medium from which a computer can read. Various forms of computer readable media may be involved in carrying sequences of instructions to a processor. For example, sequences of instruction may be delivered from RAM to a processor, may be carried over a wireless transmission medium, and/or may be formatted according to numerous formats, standards or protocols, such as Bluetooth, 4G, 5G, etc.

Where databases are described, it will be understood by one of ordinary skill in the art that alternative database structures to those described may be readily employed, and other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a non-transitory computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units. A “network” may refer to a number of computers and associated devices that may be connected by communication facilities. A network may involve permanent connections such as cables or temporary connections such as those made through the telephone or other communication links. A network may further include hardwired connections (e.g., coaxial cable, twisted pair, optical fiber, waveguides, etc.) and/or wireless connections (e.g., radio frequency waveforms, free space optical waveforms, acoustic waveforms, etc.). Examples of a network may include: an internet, such as the Internet; an intranet; a LAN; a wide area network (WAN); and a combination of networks, such as an internet and an intranet.

As noted above, in some embodiments the method or methods described above may be executed or carried out by a computing system including a non-transitory computer-readable storage medium, also described herein as a storage machine, that holds machine-readable instructions executable by a logic machine (i.e., a processor or programmable operational control portion) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a GUI, or any visual element of the methods or processes described above. For example, the display subsystem, storage machine, and logic machine may be integrated such that the above method may be executed while visual elements of the disclosed system and/or method are displayed on a display screen. The computing system may include an input subsystem that receives various inputs. The input subsystem may be configured to connect to and receive input from devices such as a mouse, keyboard, or gaming controller. For example, a user may indicate a request that certain task is to be executed by the computing system, such as requesting the computing system to display any of the above-described information or requesting that the user updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for one or more computing devices via a computer-program product such as via an application programming interface (API).

Thus, the steps of any disclosed method(s) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is new and desired to be protected by Letters Patent is set forth in the appended claims:

1. A mobility impaired rehabilitation wheelchair comprising:
a pair of front wheel assemblies;
a pair of rear wheel assemblies;
a frame connected with and supported by the pair of front wheel assemblies and the pair of rear wheel assemblies;
a movable foot rest support assembly pivotably connected to the frame at a front end thereof and comprising at least a first foot rest and a second foot rest; and
a drive assembly including at least one of a manually operated gear assembly and a motor operated assembly, and at least one coupling rod, the at least one coupling rod connected to the at least one of the manually operated gear assembly and the motor operated assembly at a first end and the movable foot rest support assembly at a second end, the at least one coupling rod configured for reciprocating motion driven by the at least one of the manually operated gear assembly and the motor operated assembly, and wherein the reciprocating motion of the at least one coupling rod causes movement of the movable foot rest support assembly between at least a first position and a second position.

2. The mobility impaired rehabilitation wheelchair of claim 1, wherein the manually operated gear assembly includes a rotatable plate attached to a first rear wheel assembly of the pair of rear wheel assemblies.

3. The mobility impaired rehabilitation wheelchair of claim 2, wherein the at least one coupling rod is attached at the first end thereof to the rotatable plate, and at the second end thereof to the movable foot rest support assembly, thereby connecting the first rear wheel assembly of the pair of rear wheel assemblies to the movable foot rest support assembly such that manual rotation of the first rear wheel assembly of the pair of rear wheel assemblies causes rotation of the rotatable plate, causing the reciprocating motion of the at least one coupling rod and thereby causing the movement of the movable foot rest support assembly between at least the first position and the second position.

4. The mobility impaired rehabilitation wheelchair of claim 3, further comprising a plurality of coupling rod adjustment portions disposed at the second end of the at least one coupling rod, each of the plurality of coupling rod adjustment portions configured to attach the at least one coupling rod to the movable foot rest support assembly.

5. The mobility impaired rehabilitation wheelchair of claim 4, further comprising a plurality of rotation adjustment portions, each of the plurality rotation adjustment portions configured to attach the at least one coupling rod to the first rear wheel assembly of the pair of rear wheel assemblies.

6. The mobility impaired rehabilitation wheelchair of claim 5, wherein the plurality of coupling rod adjustment portions and the plurality of rotation adjustment portions enable variable positioning of the at least one coupling rod.

7. The mobility impaired rehabilitation wheelchair of claim 6, further comprising a lever arm including a lever arm support, a lever arm support hinge pin, a lever arm hinge joint, a first end and a second end.

8. The mobility impaired rehabilitation wheelchair of claim 7, wherein the lever arm is capable of being placed in a first position and a second position via the lever arm hinge joint and the lever arm hinge pin, and wherein the first position of the lever arm disables a manual mode of operation of the mobility impaired rehabilitation wheelchair and the second position of the lever arm enables the manual mode of operation of the mobility impaired rehabilitation wheelchair.

9. The mobility impaired rehabilitation wheelchair of claim 8, wherein the manually operated gear assembly further includes a first drive gear connected with the first end of the lever arm and in contact with a first side of the rotatable plate, a second drive gear in contact with the first rear wheel assembly of the pair of rear wheel assemblies and capable of applying a driving force to thereto, and a third drive gear in contact with the first end of the lever arm and the first side of the rotatable plate.

10. The mobility impaired rehabilitation wheelchair of claim 9, wherein the third drive gear is capable of being engaged and mated to the first drive gear and the second gear when the lever arm is in the second position and disengaged and unmated with the first drive gear and the second drive gear when the lever arm is in the first position, and wherein the first drive gear, the second drive gear, and the third drive gear are capable of applying a first driving force to the coupling rod when the lever arm is in the second position and the mobility impaired rehabilitation wheelchair is in motion due to the manual rotational.

11. The mobility impaired rehabilitation wheelchair of claim 1, wherein the motor operated assembly includes a coupling horizontal drive, an electric motor in communication with the coupling horizontal drive, and a battery capable of powering the electric motor.

12. The mobility impaired rehabilitation wheelchair of claim 11, wherein the at least one coupling rod is attached at the first end thereof to the coupling horizontal drive, and at the second end thereof to the movable foot rest support assembly, thereby connecting the coupling horizontal drive to the movable foot rest support assembly, and wherein the electrical motor is configured to cause the reciprocating motion of the at least one coupling rod at the first end thereof within the coupling horizontal drive, thereby causing the movement of the movable foot rest support assembly between at least the first position and the second position.

13. The mobility impaired rehabilitation wheelchair of claim 12, further comprising a control panel capable of operating and controlling the motor operated assembly.

14. The mobility impaired rehabilitation wheelchair of claim 13, further comprising an audio device, enabling operation and control of the motor operated assembly via voice commands.

15. The mobility impaired rehabilitation wheelchair of claim 1, wherein the at least one coupling rod includes a first coupling rod attached at a first side of the mobility impaired rehabilitation wheelchair and in communication with the manually operated gear assembly, wherein the at least one coupling rod further includes a second coupling rod attached at a second side of the mobility impaired rehabilitation wheelchair and in communication with the motor operated assembly.

16. The mobility impaired rehabilitation wheelchair of claim 15, wherein the electric motor causes the reciprocating motion of the at least one coupling rod only when the lever arm is in the first position.

17. A mobility impaired rehabilitation wheelchair having a manual mode of operation and a motorized mode of operation, the mobility impaired rehabilitation wheelchair comprising:
a pair of front wheel assemblies;
a pair of rear wheel assemblies;
a frame connected with and supported by the pair of front wheel assemblies and the pair of rear wheel assemblies;
a movable foot rest support assembly pivotably connected to the frame at a front end thereof and comprising at least a first foot rest and a second foot rest;
a lever arm comprising a lever arm support, a lever arm support hinge pin, a lever arm hinge joint, a first end and a second end, the lever arm capable of being placed in a first position and a second position via the lever arm hinge joint and the lever arm hinge pin;
a manually operated gear assembly for enabling the manual mode of operation of the mobility impaired rehabilitation wheelchair, the manually operated gear assembly including a rotatable plate attached to a first rear wheel assembly of the pair of rear wheel assemblies, a first drive gear connected with the first end of the lever arm and in contact with a first side of the rotatable plate, a second drive gear in contact with the first rear wheel assembly of the pair of rear wheel assemblies and capable of applying a driving force thereto, and a third drive gear in contact with the first end of the lever arm and the first side of the rotatable plate, the third drive gear capable of being engaged and mated to the first drive gear and the second gear when the lever arm is in the second position and disengaged and unmated with the first drive gear and the second drive gear when the lever arm is in the first position;
a first coupling rod attached at a first end thereof to the rotatable plate and at a second end thereof to the movable foot rest support assembly, thereby connecting the first rear wheel assembly of the pair of rear wheel assemblies to the movable foot rest support assembly such that manual rotation of the first rear wheel assembly of the pair of rear wheel assemblies causes rotation of the rotatable plate, causing reciprocating motion of the first coupling rod and thereby causing movement of the movable foot rest support assembly between at least a first position and a second position when the lever arm is in the second position and the mobility impaired rehabilitation wheelchair is in motion due to the manual rotation;
a motor operated assembly for enabling the motorized mode of operation of the mobility impaired rehabilitation wheelchair, the motor operated assembly including a coupling horizontal drive disposed about the frame, an electric motor in communication with the coupling horizontal drive, and a battery capable of powering the electric motor;
a second coupling rod attached at a first end thereof to the coupling horizontal drive, and at a second end thereof to the movable foot rest support assembly, thereby connecting the coupling horizontal drive to the movable foot rest support assembly, and wherein the electrical motor is configured to cause reciprocating motion of the second coupling rod at the first end thereof within the coupling horizontal drive, thereby causing movement of the movable foot rest support assembly between at least the first position and the second position when the lever arm is in the first position; and
a control panel capable of operating and controlling the motor operated assembly.

18. The mobility impaired rehabilitation wheelchair of claim 17, wherein the mobility impaired rehabilitation wheelchair further comprises a plurality of coupling rod adjustment portions disposed at the second end of the first coupling rod, each of the plurality of coupling rod adjustment portions configured to attach the first coupling rod to the movable foot rest support assembly;
wherein the mobility impaired rehabilitation wheelchair further comprises comprising a plurality of rotation adjustment portions, each of the plurality rotation adjustment portions configured to attach the first coupling rod to the first rear wheel assembly of the pair of rear wheel assemblies; and
wherein the plurality of coupling rod adjustment portions and the plurality of rotation adjustment portions enable variable positioning of the first coupling rod.

19. The mobility impaired rehabilitation wheelchair of claim 17, further comprising an audio device, enabling operation and control of the motor operated assembly via voice commands.

20. A mobility impaired rehabilitation assembly for a wheelchair, the mobility impaired rehabilitation assembly comprising:
a movable foot rest support assembly pivotably connected to a frame of the wheelchair at a front end thereof and comprising at least a first foot rest and a second foot rest;
a lever arm comprising a lever arm support, a lever arm support hinge pin, a lever arm hinge joint, a first end and a second end, the lever arm capable of being placed in a first position and a second position via the lever arm hinge joint and the lever arm hinge pin;
a manually operated gear assembly including a rotatable plate attached to a first rear wheel assembly of the wheelchair, a first drive gear connected with the first end of the lever arm and in contact with a first side of the rotatable plate, a second drive gear in contact with the first rear wheel assembly of the wheelchair and capable of applying a driving force thereto, and a third drive gear in contact with the first end of the lever arm and the first side of the rotatable plate, the third drive gear capable of being engaged and mated to the first drive gear and the second drive gear when the lever arm is in the second position and disengaged and unmated with the first drive gear and the second drive gear when the lever arm is in the first position;
a first coupling rod attached at a first end thereof to the rotatable plate and at a second end thereof to the movable foot rest support assembly, thereby connecting the first rear wheel assembly of the wheelchair to the movable foot rest support assembly such that manual rotation of the first rear wheel assembly of the wheelchair causes rotation of the rotatable plate, causing reciprocating motion of the first coupling rod and thereby causing the movement of the movable foot rest support assembly between at least a first position and a second position when the lever arm is in the second position and the mobility impaired rehabilitation wheelchair is in motion due to the manual rotation thereof;
a motor operated assembly including a coupling horizontal drive disposed about the frame, an electric motor in communication with the coupling horizontal drive, and a battery capable of powering the electric motor;
a second coupling rod attached at a first end thereof to the coupling horizontal drive, and at a second end thereof to the movable foot rest support assembly, thereby connecting the coupling horizontal drive to the movable foot rest support assembly, and wherein the electrical motor is configured to cause reciprocating motion of the second coupling rod at the first end thereof within the coupling horizontal drive, thereby causing movement of the movable foot rest support assembly between at least the first position and the second position when the lever arm is in the first position; and
a control panel capable of operating and controlling the motor operated assembly.
